(19) United States
(12) Patent Application Publication
(10) Pub. No.: US 2025/0322249 A1
(43) Pub. Date: Oct. 16, 2025

(54) DUAL-LAYERED ARTIFICIAL INTELLIGENCE SYSTEM WITH LARGE LANGUAGE MODELS AND DIFFERENT VIRTUAL AGENTS

(71) Applicant: BitHuman Inc, SAN FRANCISCO, CA (US)

(72) Inventors: Joseph P Robinson, Salisbury, MA (US); Yun Fu, Newton, MA (US)

(73) Assignee: BitHuman Inc, SAN FRANCISCO, CA (US)

(21) Appl. No.: 18/634,939

(22) Filed: Apr. 13, 2024

(51) Int. Cl. G06N 3/091

(52) U.S. Cl. CPC G06N 3/091

(57) ABSTRACT

Embodiments of the present disclosure may include a dual-layered artificial intelligence system including a leading virtual agent and a set of other virtual agents: the leading agent, equipped with vast general knowledge, interfaces with the user and enforces guidelines in the overarching goal and progress, branding, guiderails, regulatory compliance, and the system's voice, while the other agents contain vast knowledge in a specific domain. These other agents only communicate with the leading agent and are called upon by the leading agent when their respective expertise is needed to solve the goal.

### BACKGROUND OF THE INVENTION

Embodiments of the present disclosure may include a dual-layered artificial intelligence system and methods to include dual-layer artificial visual agents.

### BRIEF SUMMARY

Embodiments of the present disclosure may include a dual-layered artificial intelligence system including a leading virtual agent with a first large language model. In some embodiments, the first large language model may be trained with datasets that include goal setting, progress tracking, ethical guidelines, brand voice, and regulatory compliance.

In some embodiments, the first large language model may be trained with a second set of datasets that encompass general knowledge, specific domain ability, and user interaction protocols. In some embodiments, the leading virtual agent with the first large language model may be trained to be an expert for high-level tasks. In some embodiments, the leading virtual agent may be only one virtual agent that may be informed that the leading virtual agent may be configured to guide other agents to a higher-level task within the dual-layered artificial intelligence system.

In some embodiments, the leading virtual agent may be only virtual agent that may be configured to interface with any customer. In some embodiments, the leading virtual agent may be configured to perform any higher-level task that leads other task-specific agents. Embodiments may also include a set of other virtual agents with a set of large language models individually, each of the set of other virtual agents may be trained by a specified large language model of the set of large language models.

In some embodiments, the set of large language models may be trained with specialized focuses that may be called upon at any given moment from the leading virtual agent. In some embodiments, the leading virtual agent may be configured to monitor the set of other virtual agents. In some embodiments, the leading virtual agent may be configured to ensure the set of other virtual agents to adhere to a broader set of goals.

In some embodiments, a process of the monitoring and ensuring may be analogous to how a teacher may use a curriculum to keep a course on track. In some embodiments, the process may be configured to serve as guardrails to ensure that outputs stay within predefined parameters. In some embodiments, a set of predefined parameters may include brand consistency, ethical considerations, and other overarching goals.

In some embodiments, the set of other virtual agents may be configured to have no knowledge that another virtual agent may be guiding them. In some embodiments, the set of other agents may be configured to communicate their interactions with users regularly to the leading virtual agent. In some embodiments, the leading virtual agent may be configured to drives the set of other virtual agents to deliver optimal solutions.

Embodiments may also include and. Embodiments may also include an artificial intelligence engine coupled to both the leading virtual agent and the set of other virtual agents. In some embodiments, the artificial intelligence engine may be configured to adjust input datasets and parameters of the first large language model, the second large language model and the set of large language models. In some embodiments, the artificial intelligence engine may be configured to convey instructions from the leading virtual agent to the set of other virtual agents.

Embodiments of the present disclosure may also include a method for providing services via a leading virtual agent and a set of other virtual agents with artificial intelligence, the method including detecting, by one or more processors, a request from a first user. In some embodiments, the request could be a request to be educated with a specifically tailored class with a set of other virtual agents with artificial intelligence.

In some embodiments, a specifically tailored class may be configured to execute a specific plan for the user for the education. In some embodiments, the leading virtual agent may be trained with datasets that include goal setting, progress tracking, ethical guidelines, brand voice, and regulatory compliance. In some embodiments, the leading virtual agent with the first large language model may be trained to be an expert for high-level tasks.

In some embodiments, the leading virtual agent may be only one virtual agent that may be informed that the leading virtual agent may be configured to guide other agents to a higher-level task. In some embodiments, the leading virtual agent may be only one virtual agent interfacing with users. In some embodiments, the leading virtual agent may be configured to monitor the set of other virtual agents.

In some embodiments, the leading virtual agent may be configured to ensure the set of other virtual agents to adhere to a broader set of goals. Embodiments may also include activating a first other virtual agent of the set of other virtual agents with artificial intelligence. In some embodiments, the first other virtual agent may be picked by the leading virtual agent with leading artificial intelligence.

In some embodiments, the pick of the first other virtual agent may be determined by specifications and configurations of the first other virtual agent and specific needs from the first user. In some embodiments, the first other virtual agent may be configured to give educational information and specific material to the leading virtual agent. In some embodiments, the leading virtual agent may be configured to preform educational services that may include teaching the first user, interacting with the first user, answering questions from the first user.

In some embodiments, the. In some embodiments, the set of other virtual agents may be configured to collaborate with each other. In some embodiments, the first other customer-facing virtual agent may be interacting with the leading virtual agent. In some embodiments, an artificial intelligence engine may be coupled to the one or more processors and a server and to the leading virtual agent and the set of customer-facing virtual agents.

In some embodiments, the artificial intelligence engine may be trained by human experts in the field. In some embodiments, the set of other virtual agents may be configured to be displayed in LED/OLED displays, Android/iOS tablets, Laptops/PCs, smartphones, or VR/AR goggles. In some embodiments, a set of multi-layer info panels coupled to the one or more processors may be configured to overlay graphics on top of the set of virtual agents.

In some embodiments, any of the set of other virtual agents may be configured to be displayed with appearance of a real human or a humanoid or a cartoon character. In some embodiments, any of the set of virtual agents' gender, age and ethnicity may be determined by the artificial Intelligence's analysis on input from the user. In some embodiments, any of the set of other virtual agents may be configured to be displayed in full body or half body portrait mode.

In some embodiments, the artificial intelligence engine may be configured for real-time speech recognition, speech to text generation, real-time dialog generation, text to speech generation, voice-driven animation, and human avatar generation. In some embodiments, the artificial intelligence engine may be configured to emulate different voices and use different languages.

Embodiments may also include modifying education activities from the first other virtual agent based on guidelines and input from the leading virtual agent with communication between the first other virtual agent and the leading virtual agent. Embodiments may also include recording the modification and feedback from the first user. Embodiments may also include training other virtual agents of the set of other virtual agents based on the recording.

Embodiments of the present disclosure may also include a method for providing services via a leading virtual agent and a set of other virtual agents with artificial intelligence, the method including detecting, by one or more processors, a request from a first user. In some embodiments, the request could be a request to be educated with a specifically tailored class with a set of other virtual agents with artificial intelligence.

In some embodiments, a specifically tailored class may be configured to execute a specific plan for the user for the education. In some embodiments, the leading virtual agent may be trained with datasets that include goal setting, progress tracking, ethical guidelines, brand voice, and regulatory compliance. In some embodiments, the leading virtual agent with the first large language model may be trained to be an expert for high-level tasks.

In some embodiments, the leading virtual agent may be only one virtual agent that may be informed that the leading virtual agent may be configured to guide other agents to a higher-level task. In some embodiments, the leading virtual agent may be only one virtual agent interfacing with users. In some embodiments, the leading virtual agent may be configured to monitor the set of other virtual agents.

In some embodiments, the leading virtual agent may be configured to ensure the set of other virtual agents to adhere to a broader set of goals. Embodiments may also include activating a first other virtual agent of the set of other virtual agents with artificial intelligence. In some embodiments, the first other virtual agent may be picked by the leading virtual agent with leading artificial intelligence.

In some embodiments, the pick of the first other virtual agent may be determined by specifics and configurations of the first other virtual agent and specific needs from the first user. In some embodiments, the first other virtual agent may be configured to give educational information and specific material to the leading virtual agent. In some embodiments, the leading virtual agent may be configured to preform educational service that may include teaching the first user, interacting with the first user, answering questions from the first user.

In some embodiments, the. In some embodiments, the set of other virtual agents may be configured to collaborate with each other. In some embodiments, the first other customer-facing virtual agent may be interacting with the leading virtual agent. In some embodiments, an artificial intelligence engine may be coupled to the one or more processors and a server and to the leading virtual agent and the set of customer-facing virtual agents.

In some embodiments, the artificial intelligence engine may be trained by human experts in the field. In some embodiments, the set of other virtual agents may be configured to be displayed in LED/OLED displays, Android/iOS tablets, Laptops/PCs, smartphones, or VR/AR goggles. In some embodiments, a set of multi-layer info panels coupled to the one or more processors may be configured to overlay graphics on top of the set of virtual agents.

In some embodiments, any of the set of other virtual agents may be configured to be displayed with an appearance of a real human or a humanoid or a cartoon character. In some embodiments, any of the set of virtual agents' gender, age and ethnicity may be determined by the artificial Intelligence's analysis on input from the user. In some embodiments, any of the set of other virtual agents may be configured to be displayed in full body or half body portrait mode.

In some embodiments, the artificial intelligence engine may be configured for real-time speech recognition, speech to text generation, real-time dialog generation, text to speech generation, voice-driven animation, and human avatar generation. In some embodiments, the artificial intelligence engine may be configured to emulate different voices and use different languages.

Embodiments may also include modifying education activities from the first other virtual agent based on guidelines and input from the leading virtual agent with communication between the first other virtual agent and the leading virtual agent. Embodiments may also include recording the modification and feedback from the first user. Embodiments may also include training other virtual agents of the set of other virtual agents based on the recording.

Embodiments may also include activating a second other virtual agent of the set of other virtual agents with artificial intelligence. In some embodiments, the second other virtual agent may be picked by the leading virtual agent with leading artificial intelligence. In some embodiments, the pick of the second other virtual agent may be determined by specifics and configurations of the second other virtual agent and specific needs from the second user.

In some embodiments, the second other virtual agent may be configured to give educational information and specific material to the leading virtual agent. In some embodiments, the leading virtual agent may be configured to preform educational service that may include teaching the second user, interacting with the second user, answering questions from the second user.

In some embodiments, the. In some embodiments, the set of other virtual agents may be configured to collaborate with each other. In some embodiments, the second other customer-facing virtual agent may be interacting with the leading virtual agent. In some embodiments, an artificial intelligence engine may be coupled to the one or more processors and a server and to the leading virtual agent and the set of customer-facing virtual agents.

In some embodiments, the artificial intelligence engine may be trained by human experts in the field. In some embodiments, the set of other virtual agents may be configured to be displayed in LED/OLED displays, Android/iOS tablets, Laptops/PCs, smartphones, or VR/AR goggles. In some embodiments, a set of multi-layer info panels coupled to the one or more processors may be configured to overlay graphics on top of the set of virtual agents.

In some embodiments, any of the set of other virtual agents may be configured to be displayed with an appearance of a real human or a humanoid or a cartoon character. In some embodiments, any of the set of virtual agents' gender, age and ethnicity may be determined by the artificial Intelligence's analysis on input from the user. In some embodiments, any of the set of other virtual agents may be configured to be displayed in full body or half body portrait mode.

In some embodiments, the artificial intelligence engine may be configured for real-time speech recognition, speech to text generation, real-time dialog generation, text to speech generation, voice-driven animation, and human avatar generation. In some embodiments, the artificial intelligence engine may be configured to emulate different voices and use different languages.

Embodiments may also include modifying education activities from the second other virtual agent based on guidelines and input from the leading virtual agent with communication between the second other virtual agent and the leading virtual agent. Embodiments may also include recording the modification and feedback from the second user. Embodiments may also include training other virtual agents of the set of other virtual agents based on the recording.

### BRIEF DESCRIPTION OF THE FIGURES

FIG. 1 is a block diagram illustrating a dual-layered artificial intelligence system, according to some embodiments of the present disclosure.

FIG. 2 is a flowchart illustrating a method for providing services, according to some embodiments of the present disclosure.

FIG. 3A is a flowchart illustrating a method for providing services, according to some embodiments of the present disclosure.

FIG. 3B is a flowchart extending from FIG. 3A and further illustrating the method for providing services, according to some embodiments of the present disclosure.

FIG. 4 is a diagram showing an example of a method for providing services via a dual-layer artificial intelligence system, according to some embodiments of the present disclosure.

FIG. 5 is a diagram showing a second example of a method for providing services via a dual-layer artificial intelligence system, according to some embodiments of the present disclosure.

FIG. 6 is a diagram showing a third example of a method for providing services via a dual-layer artificial intelligence system, according to some embodiments of the present disclosure.

FIG. 7 is a diagram showing a fourth example of a method for providing services via a dual-layer artificial intelligence system, according to some embodiments of the present disclosure.

FIG. 8 is a diagram showing a fifth example of a method for providing services via a dual-layer artificial intelligence system, according to some embodiments of the present disclosure.

FIG. 9 is a diagram showing a sixth example of a method for providing services via a dual-layer artificial intelligence system, according to some embodiments of the present disclosure.

FIG. 10 is a diagram showing a seventh example of a method for providing services via a dual-layer artificial intelligence system, according to some embodiments of the present disclosure.

### DETAILED DESCRIPTION

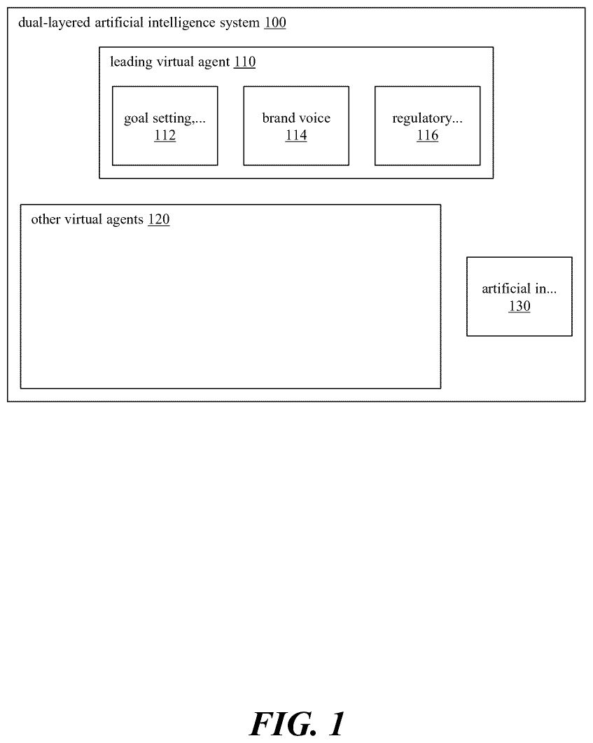

FIG. 1 is a block diagram that describes a dual-layered artificial intelligence system 100, according to some embodiments of the present disclosure. In some embodiments, the dual-layered artificial intelligence system 100 may include a leading virtual agent 110 and an artificial intelligence engine 130 coupled to both the leading virtual agent and the set of other virtual agents 120. The dual-layered artificial intelligence system 100 may also include a set of other virtual agents 120 with a set of large language models individually, each of the set of other virtual agents 120 may be trained by a specified large language model of the set of large language models.

In some embodiments, the leading virtual agent 110 may include brand voice 114 and regulatory compliance 116. The leading virtual agent 110 may also include goal setting, progress tracking, ethical guidelines 112. The first large language model may be trained with datasets that. The first large language model may be trained with a second set of datasets that encompass general knowledge, specific domain ability, and user interaction protocols.

In some embodiments, the leading virtual agent 110 with the first large language model may be trained to be an expert for high-level tasks. The leading virtual agent 110 may be only one virtual agent that may be informed that the leading virtual agent 110 may be configured to guide other agents to a higher-level task within the dual-layered artificial intelligence system 100. The leading virtual agent 110 may be only virtual agent that may be configured to interface with any customer.

In some embodiments, the leading virtual agent 110 may be configured to perform any higher-level task that leads other task-specific agents. The set of large language models may be trained with specialized focuses that may be called upon at any given moment from the leading virtual agent 110.

In some embodiments, the leading virtual agent 110 may be configured to monitor the set of other virtual agents 120. The leading virtual agent 110 may be configured to ensure the set of other virtual agents 120 to adhere to a broader set of goals. A process of monitoring and ensuring may be analogous to how a teacher may use a curriculum to keep a course on track. The process may be configured to serve as guardrails to ensure that outputs may stay within predefined parameters.

In some embodiments, a set of predefined parameters. The other overarching goals may have no knowledge that another virtual agent may be guiding them. The set of other virtual agents 120 may be configured to. The set of other agents may be configured to communicate their interactions with users regularly to the leading virtual agent 110. The leading virtual agent 110 may be configured to drive the set of other virtual agents 120 to deliver optimal solutions. The artificial intelligence engine 130 may be configured to adjust input datasets and parameters of the first large language model, the second large language model and the set of large language models. The artificial intelligence engine 130 may be configured to convey instructions from the leading virtual agent to the set of other virtual agents 120.

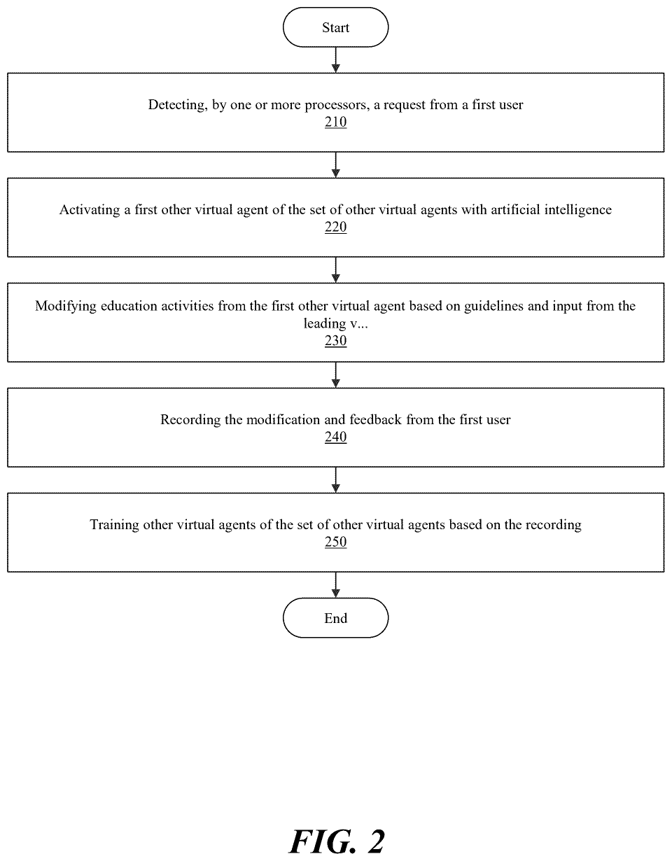

FIG. 2 is a flowchart that describes a method for providing services, according to some embodiments of the present disclosure. In some embodiments, at 210, the method may include detecting, by one or more processors, a request from a first user. At 220, the method may include activating a first other virtual agent of the set of other virtual agents with artificial intelligence. At 230, the method may include modifying education activities from the first other virtual agent based on guidelines and input from the leading virtual agent with communication between the first other virtual agent and the leading virtual agent. At 240, the method may include recording the modification and feedback from the first user. At 250, the method may include training other virtual agents of the set of other virtual agents based on the recording.

In some embodiments, the request could be a request to be educated with a specifically tailored class with a set of other virtual agents with artificial intelligence. A specifically tailored class may be configured to execute a specific plan for the user for the education. The leading virtual agent may be trained with datasets that include goal setting, progress tracking, ethical guidelines, brand voice, and regulatory compliance.

In some embodiments, the leading virtual agent with the first large language model may be trained to be an expert for high-level tasks. The leading virtual agent may be only one virtual agent that may be informed that the leading virtual agent may be configured to guide other agents to a higher-level task. The leading virtual agent may be only one virtual agent interfacing with users. The leading virtual agent may be configured to monitor the set of other virtual agents.

In some embodiments, the leading virtual agent may be configured to ensure the set of other virtual agents to adhere to a broader set of goals. The first other virtual agent may be picked by the leading virtual agent with leading artificial intelligence. The pick of the first other virtual agent may be determined by specifics and configurations of the first other virtual agent and specific needs from the first user. The first other virtual agent may be configured to give educational information and specific material to the leading virtual agent.

In some embodiments, the leading virtual agent may be configured to preform educational service that comprises teaching the first user, interacting with the first user, answering questions from the first user. The. The set of other virtual agents may be configured to collaborate with each other. The first other customer-facing virtual agent may be interacting with the leading virtual agent. An artificial intelligence engine may be coupled to the one or more processors and a server and to the leading virtual agent and the set of customer-facing virtual agents.

In some embodiments, the artificial intelligence engine may be trained by human experts in the field. The set of other virtual agents may be configured to be displayed in LED/OLED displays, Android/iOS tablets, Laptops/PCs, smartphones, or VR/AR goggles. A set of multi-layer info panels coupled to the one or more processors may be configured to overlay graphics on top of the set of virtual agents. Any of the set of other virtual agents may be configured to be displayed with an appearance of a real human or a humanoid or a cartoon character.

In some embodiments, any of the set of virtual agents' gender, age and ethnicity may be determined by the artificial Intelligence's analysis on input from the user. Any of the set of other virtual agents may be configured to be displayed in full body or half body portrait mode. The artificial intelligence engine may be configured for real-time speech recognition, speech to text generation, real-time dialog generation, text to speech generation, voice-driven animation, and human avatar generation. The artificial intelligence engine may be configured to emulate different voices and use different languages.

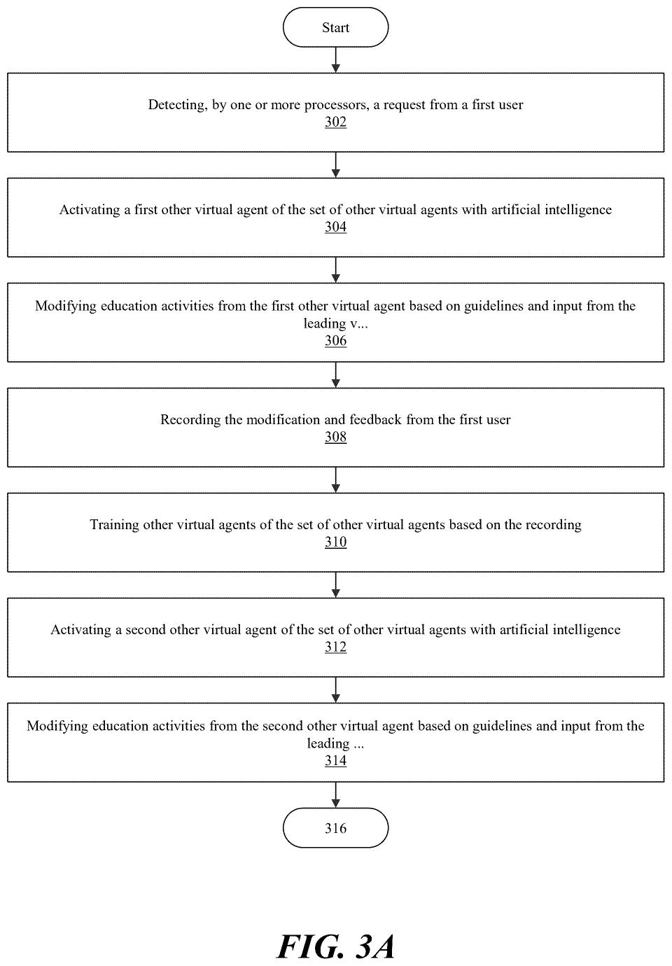

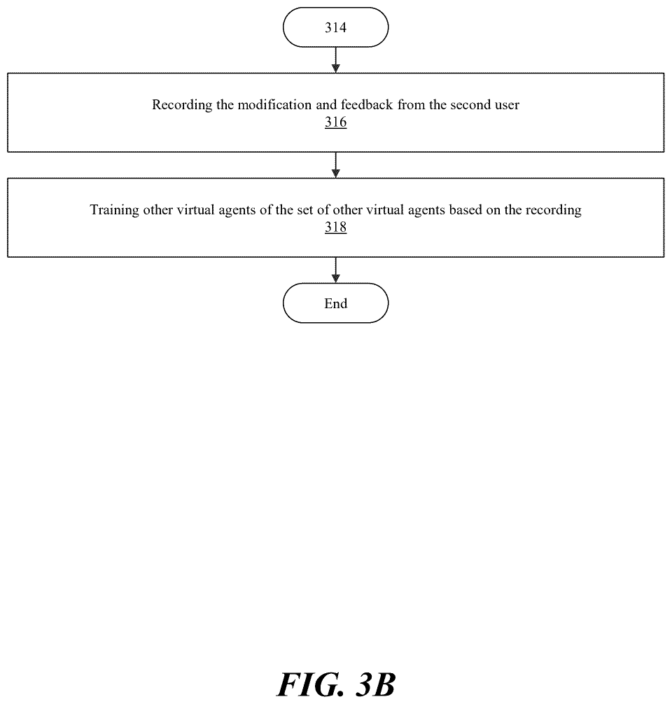

FIGS. 3A to 3B are flowcharts that describe a method for providing services, according to some embodiments of the present disclosure. In some embodiments, at 302, the method may include detecting, by one or more processors, a request from a first user. At 304, the method may include activating a first other virtual agent of the set of other virtual agents with artificial intelligence. At 306, the method may include modifying education activities from the first other virtual agent based on guidelines and input from the leading virtual agent with communication between the first other virtual agent and the leading virtual agent.

In some embodiments, at 308, the method may include recording the modification and feedback from the first user. At 310, the method may include training other virtual agents of the set of other virtual agents based on the recording. At 312, the method may include activating a second other virtual agent of the set of other virtual agents with artificial intelligence. At 314, the method may include modifying education activities from the second other virtual agent based on guidelines and input from the leading virtual agent with communication between the second other virtual agent and the leading virtual agent. At 316, the method may include recording the modification and feedback from the second user. At 318, the method may include training other virtual agents of the set of other virtual agents based on the recording.

In some embodiments, the request could be a request to be educated with a specifically tailored class with a set of other virtual agents with artificial intelligence. A specifically tailored class may be configured to execute a specific plan for the user for the education. The leading virtual agent may be trained with datasets that include goal setting, progress tracking, ethical guidelines, brand voice, and regulatory compliance.

In some embodiments, the leading virtual agent with the first large language model may be trained to be an expert for high-level tasks. The leading virtual agent may be only one virtual agent that may be informed that the leading virtual agent may be configured to guide other agents to a higher-level task. The leading virtual agent may be only one virtual agent interfacing with users. The leading virtual agent may be configured to monitor the set of other virtual agents.

In some embodiments, the leading virtual agent may be configured to ensure the set of other virtual agents to adhere to a broader set of goals. The first other virtual agent may be picked by the leading virtual agent with leading artificial intelligence. The pick of the first other virtual agent may be determined by specifics and configurations of the first other virtual agent and specific needs from the first user. The first other virtual agent may be configured to give educational information and specific material to the leading virtual agent.

In some embodiments, the leading virtual agent may be configured to preform educational service that comprises teaching the first user, interacting with the first user, answering questions from the first user. The. The set of other virtual agents may be configured to collaborate with each other. The first other customer-facing virtual agent may be interacting with the leading virtual agent. An artificial intelligence engine may be coupled to the one or more processors and a server and to the leading virtual agent and the set of customer-facing virtual agents.

In some embodiments, the artificial intelligence engine may be trained by human experts in the field. The set of other virtual agents may be configured to be displayed in LED/OLED displays, Android/iOS tablets, Laptops/PCs, smartphones, or VR/AR goggles. A set of multi-layer info panels coupled to the one or more processors may be configured to overlay graphics on top of the set of virtual agents. Any of the set of other virtual agents may be configured to be displayed with an appearance of a real human or a humanoid or a cartoon character.

In some embodiments, any of the set of virtual agents' gender, age and ethnicity may be determined by the artificial Intelligence's analysis on input from the user. Any of the set of other virtual agents may be configured to be displayed in full body or half body portrait mode. The artificial intelligence engine may be configured for real-time speech recognition, speech to text generation, real-time dialog generation, text to speech generation, voice-driven animation, and human avatar generation.

In some embodiments, the artificial intelligence engine may be configured to emulate different voices and use different languages. The second other virtual agent may be picked by the leading virtual agent with leading artificial intelligence. The pick of the second other virtual agent may be determined by specifics and configurations of the second other virtual agent and specific needs from the second user. The second other virtual agent may be configured to give educational information and specific material to the leading virtual agent.

In some embodiments, the leading virtual agent may be configured to preform educational service that comprises teaching the second user, interacting with the second user, answering questions from the second user. The. The set of other virtual agents may be configured to collaborate with each other. The second other customer-facing virtual agent may be interacting with the leading virtual agent. An artificial intelligence engine may be coupled to the one or more processors and a server and to the leading virtual agent and the set of customer-facing virtual agents.

In some embodiments, the artificial intelligence engine may be trained by human experts in the field. The set of other virtual agents may be configured to be displayed in LED/OLED displays, Android/iOS tablets, Laptops/PCs, smartphones, or VR/AR goggles. A set of multi-layer info panels coupled to the one or more processors may be configured to overlay graphics on top of the set of virtual agents. Any of the set of other virtual agents may be configured to be displayed with an appearance of a real human or a humanoid or a cartoon character.

In some embodiments, any of the set of virtual agents' gender, age and ethnicity may be determined by the artificial Intelligence's analysis on input from the user. Any of the set of other virtual agents may be configured to be displayed in full body or half body portrait mode. The artificial intelligence engine may be configured for real-time speech recognition, speech to text generation, real-time dialog generation, text to speech generation, voice-driven animation, and human avatar generation. The artificial intelligence engine may be configured to emulate different voices and use different languages.

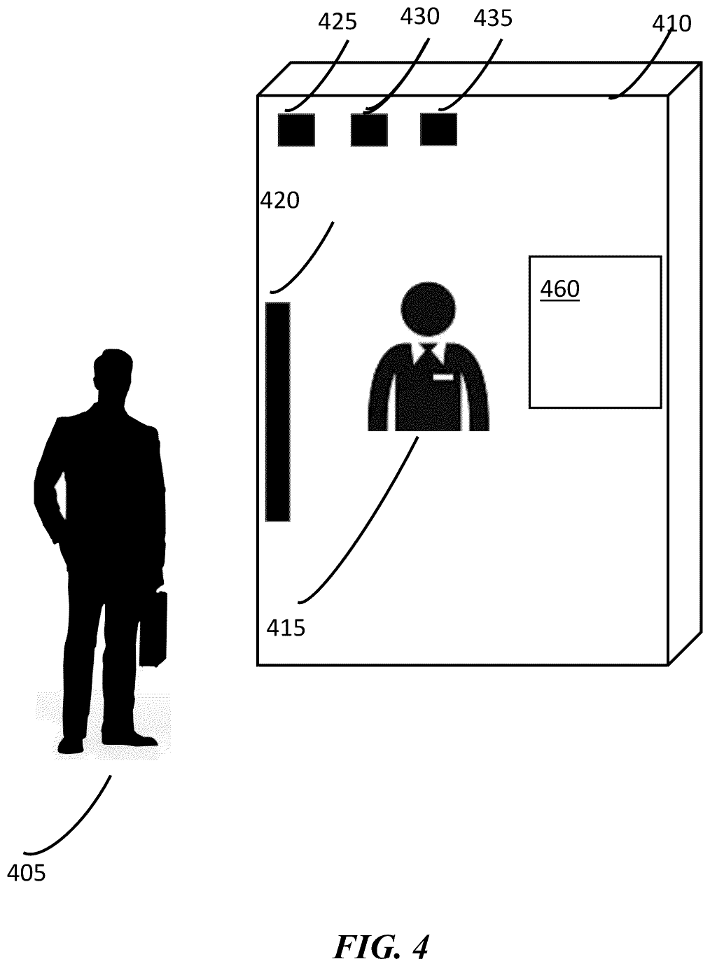

FIG. 4 is a diagram showing an example that describes the first example of a method for providing services via a dual-layer artificial intelligence system, according to some embodiments of the present disclosure.

In some embodiments, a user 405 can approach a smart display 410. In some embodiments, the smart display 410 could be LED or OLED-based. In some embodiments, interactive panels 420 are attached to the smart display 410. In some embodiments, camera 425, sensor 430 and microphone 435 are attached to the smart display 410. In some embodiments, an artificial intelligence visual assistant with customer-facing duty 415 is active on the smart display 410. In some embodiments, a leading visual agent is guiding the artificial intelligence visual assistant with customer-facing duty 415 without the knowledge of the artificial intelligence visual assistant with customer-facing duty 415. In some embodiments, a visual working agenda 460 is shown on the smart display 410. In some embodiments, user 405 can approach the smart display 410 and initiate and complete the intended business with the visual assistant 415 by the methods described in FIG. 1-FIG. 3. In some embodiments, interactive panel 420 is coupled to a central processor. In some embodiments, interactive panel 420 is coupled to a server via a wireless link. In some embodiments, user 405 can interact with the visual assistant 415 via camera 425, sensor 430 and microphone 435 using methods described in FIG. 1-FIG. 3, with the help of interactive panel 420. In some embodiments, user 405 can choose what language to use. In some embodiments, other users can use this service described in this paragraph. In some embodiments, the user is able to interact with multiple AI visual agents as described in this example and the system and methods described in FIG. 1-3.

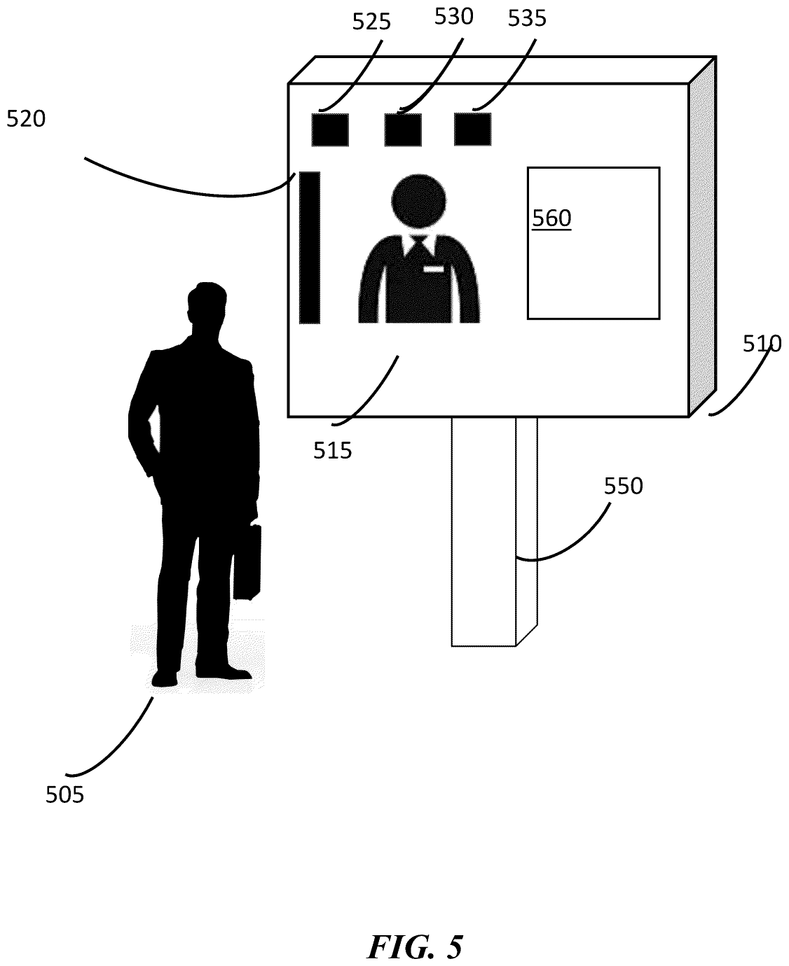

FIG. 5 is a diagram showing a second example of a method for providing services via a dual-layer artificial intelligence system, according to some embodiments of the present disclosure.

In some embodiments, a user 505 can approach a smart display 510. In some embodiments, the smart display 510 could be LED or OLED-based. In some embodiments, interactive panels 520 are attached to the smart display 510. In some embodiments, camera 525, sensor 530, and microphone 535 are attached to the smart display 510. In some embodiments, a support column 550 is attached to the smart display 510. In some embodiments, an artificial intelligence visual assistant with customer-facing duty 515 is active on the smart display 510. In some embodiments, a leading visual agent is guiding the artificial intelligence visual assistant with customer-facing duty 515 without the knowledge of the artificial intelligence visual assistant with customer-facing duty 515. In some embodiments, a visual working agenda 560 is shown on the smart display 510. In some embodiments, user 505 can approach the smart display 510 and initiate and complete the business process with the visual assistant 515 by the methods described in FIG. 1-FIG. 3. In some embodiments, interactive panel 520 is coupled to a central processor. In some embodiments, interactive panel 520 is coupled to a server via a wireless link. In some embodiments, user 505 can interact with the visual assistant 515 via camera 525, sensor 530 and microphone 535 using methods described in FIG. 1-FIG. 3., with the help of interactive panel 520. In some embodiments, user 505 can choose what language to be used. In some embodiments, other users can use this service descripted in this paragraph. In some embodiments, other users can use this service described in this paragraph. In some embodiments, the user can interact with multiple AI visual assistants as described in this example and the system and methods described in FIG. 1-3.

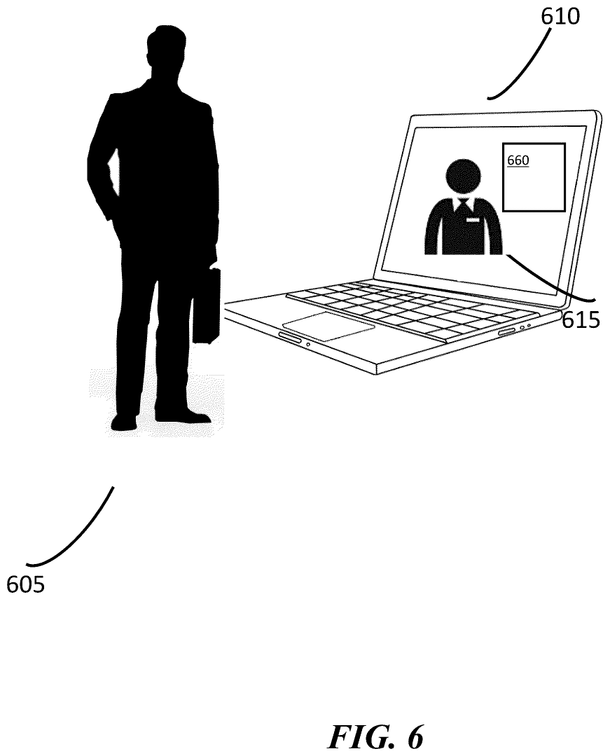

FIG. 6 is a diagram showing a third example of a method for providing services via a dual-layer artificial intelligence system, according to some embodiments of the present disclosure.

In some embodiments, a user 605 can approach a smart display 610. In some embodiments, the smart display 610 could be LED or OLED-based. In some embodiments, the display 610 could be a part of a desktop computer, a laptop computer or a tablet computer. In some embodiments, a camera, sensor, and microphone are attached to the smart display 610. In some embodiments, an artificial intelligence visual assistant 615 with customer-facing duty is active on the smart display 610. In some embodiments, a leading visual agent is guiding the artificial intelligence visual assistant with customer-facing duty 615 without the knowledge of the artificial intelligence visual assistant with customer-facing duty 615. In some embodiments, a visual working agenda 660 is shown on the smart display 610. In some embodiments, user 605 can approach the smart display 610 and initiate and complete the business process with the visual assistant 615 by the methods described in FIG. 1-FIG. 3. In some embodiments, a keyboard is coupled to a central processor. In some embodiments, a keyboard is coupled to a server via a wireless link. In some embodiments, user 605 can interact with the visual assistant 615 via a camera, sensor and microphone using methods described in FIG. 1-FIG. 3, with the help of the keyboard. In some embodiments, user 605 can choose what language to use. In some embodiments, other users can use this service descripted in this paragraph. In some embodiments, other users can use this service described in this paragraph. In some embodiments, the user is able to interact with multiple AI visual assistants as described in this example and the system and methods described in FIG. 1-3.

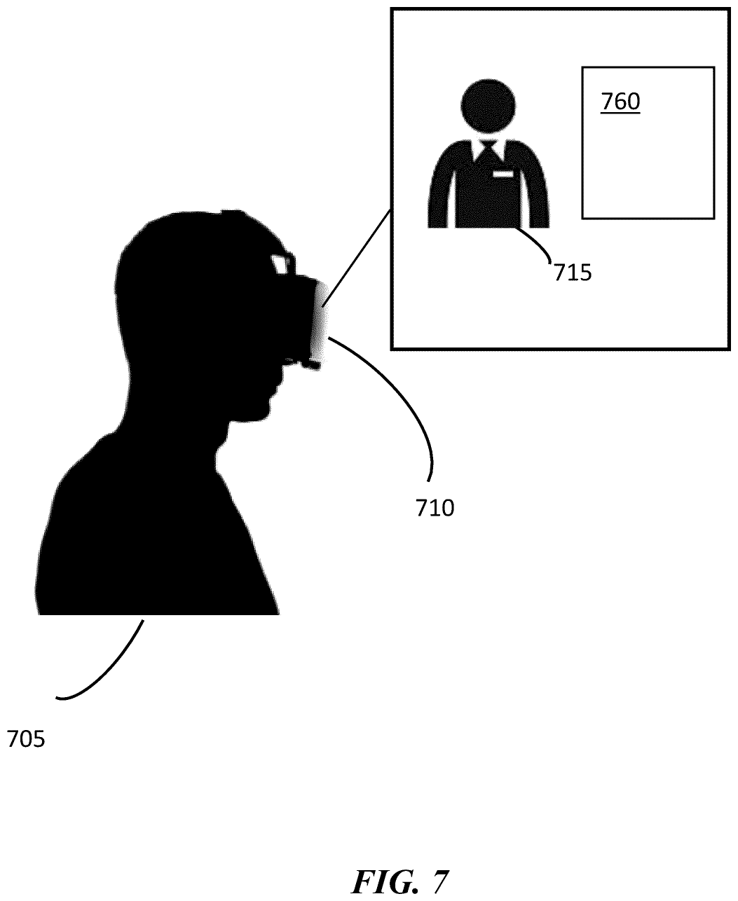

FIG. 7 is a diagram showing a fourth example of a method for providing services via a dual-layer artificial intelligence system, according to some embodiments of the present disclosure.

In some embodiments, a user 705 can view programs including news with a VR or AR device 710. In some embodiments, a processor and a server are connected to the VR or AR device 710. In some embodiments, an interactive keyboard is connected to the VR or AR device 710. In some embodiments, an AI visual assistant 715 with customer-facing duty is active on the VR or AR device 710. In some embodiments, a leading visual agent is guiding the AI visual assistant with customer-facing duty 715 without the knowledge of the AI visual assistant with customer-facing duty 715. In some embodiments, a visual working agenda 760 is shown on the VR or AR 710. In some embodiments, user 705 can initiate and complete the business process with the visual assistant 705 via the VR or AR device 715 by the methods described in FIG. 1-FIG. 3. In some embodiments, an interactive panel is coupled to a central processor. In some embodiments, an interactive panel is coupled to a server via a wireless link. In some embodiments, the user 705 can choose what language to use. In some embodiments, other users can use this service described in this paragraph. In some embodiments, other users can use this service described in this paragraph. In some embodiments, the user is able to interact with multiple AI visual assistants as described in this example and the system and methods described in FIG. 1-3.

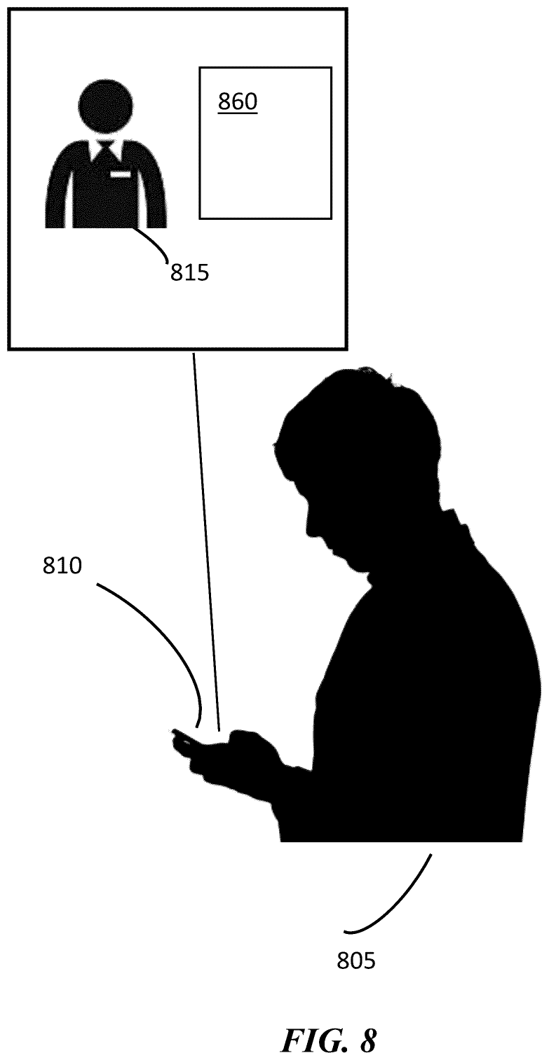

FIG. 8 is a diagram showing a fifth example of a method for providing services via a dual-layer artificial intelligence system, according to some embodiments of the present disclosure.

In some embodiments, a user 805 can view programs including news with a smartphone device 810. In some embodiments, a processor and a server are connected to the smartphone device 810. In some embodiments, an interactive keyboard is connected to the smartphone device 810. In some embodiments, an AI visual assistant 815 with customer-facing duty is active on the smartphone device 810. In some embodiments, a leading visual agent is guiding the AI visual assistant with customer-facing duty 815 without the knowledge of the AI visual assistant with customer-facing duty 815. In some embodiments, a visual working agenda 860 is shown on the smartphone device 810. In some embodiments, user 805 can initiate and complete the business process with the visual assistant 815 via smartphone device 810 by the methods described in FIG. 1-FIG. 3. In some embodiments, an interactive panel is coupled to a central processor. In some embodiments, interactive panel is coupled to a server via a wireless link. In some embodiments, the user 805 can choose what language to be used. In some embodiments, other users can use this service descripted in this paragraph. In some embodiments, other users can use this service described in this paragraph. In some embodiments, the user is able to interact with multiple AI visual assistants as described in this example and the system and methods described in FIG. 1-3.

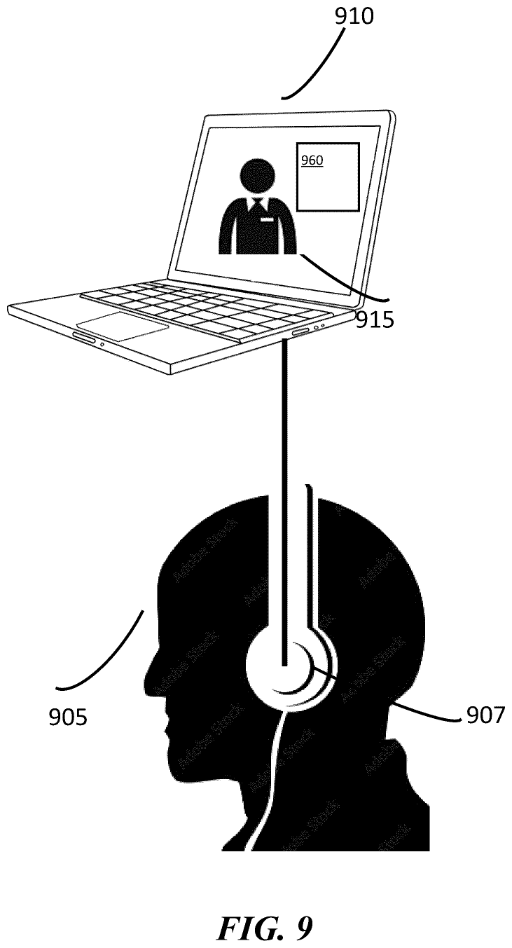

FIG. 9 is a diagram showing a sixth example of a method for providing services via a dual-layer artificial intelligence system, according to some embodiments of the present disclosure.

In some embodiments, a user 905 has a brain-computer interface. In some embodiments, the user 905 may wear a headset 907 that can detect and translate the electric signal from the brain and communicate with the computer or other devices. The computer 910 or other devices are connected with a cable or wire to the headset. In some embodiments, a processor and a server are connected to the computer 910. In some embodiments, an interactive keyboard is connected to the computer 910. In some embodiments, an AI visual assistant 915 with customer-facing duty is active on the computer 910. In some embodiments, a leading visual agent is guiding the AI visual assistant with customer-facing duty 915 without the knowledge of the AI visual assistant with customer-facing duty 915. In some embodiments, a visual working agenda 960 is shown on the computer 910. In some embodiments, user 905 can initiate and complete the business process with the visual assistant 905 via the computer 915 by the methods described in FIG. 1-FIG. 3. In some embodiments, an interactive panel is coupled to a central processor. In some embodiments, an interactive panel is coupled to a server via a wireless link. In some embodiments, the user 905 can choose what language to use. In some embodiments, other users can use this service descripted in this paragraph. In some embodiments, other users can use this service described in this paragraph. In some embodiments, the user is able to interact with multiple AI visual assistants as described in this example and the system and methods described in FIG. 1-3.

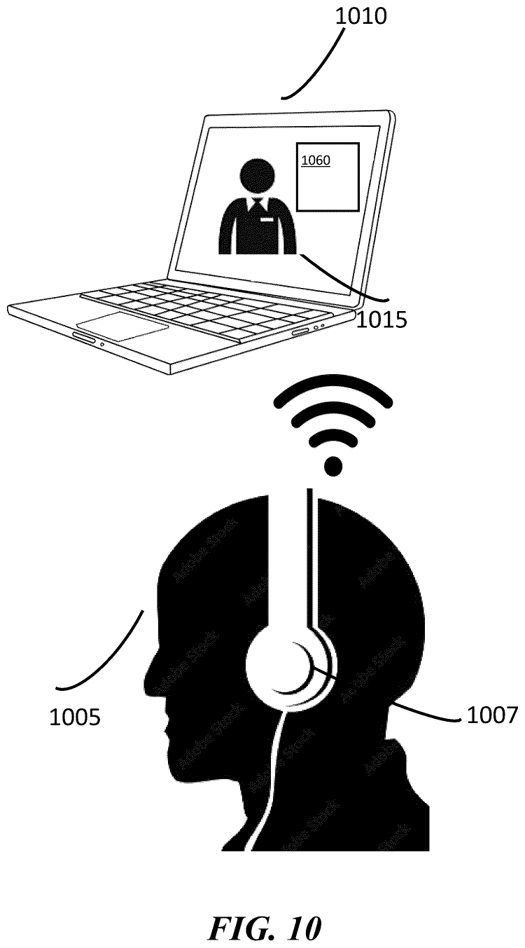

FIG. 10 is a diagram showing a seventh example of a method for providing services via a dual-layer artificial intelligence system, according to some embodiments of the present disclosure.

In some embodiments, a user 1005 has a brain-computer interface. In some embodiments, the user 1005 may wear a headset 1007 that can detect and translate the electric signal from the brain and communicate with the computer or other devices. The computer 1010 or other devices are connected with wireless means to the headset. In some embodiments, a processor and a server are connected to the computer 1010. In some embodiments, an interactive keyboard is connected to the computer 1010. In some embodiments, an AI visual assistant 1015 with customer-facing duty is active on the computer 1010. In some embodiments, a leading visual agent is guiding the AI visual assistant with customer-facing duty 1015 without the knowledge of the AI visual assistant with customer-facing duty 1015. In some embodiments, a visual working agenda 1060 is shown on the computer 1010. In some embodiments, user 1005 can initiate and complete the business process with the visual assistant 1005 via the computer 1015 by the methods described in FIG. 1-FIG. 3. In some embodiments, an interactive panel is coupled to a central processor. In some embodiments, an interactive panel is coupled to a server via a wireless link. In some embodiments, the user 1005 can choose what language to use. In some embodiments, other users can use this service descripted in this paragraph. In some embodiments, other users can use this service described in this paragraph. In some embodiments, the user is able to interact with multiple AI visual assistants as described in this example and the system and methods described in FIG. 1-3.

1. A dual-layered artificial intelligence system comprising:
A leading virtual agent with a first large language model, wherein the first large language model is trained with datasets that include goal setting, progress tracking, ethical guidelines, brand voice, and regulatory compliance, wherein the first large language model is trained with a second set of datasets that encompass general knowledge, specific domain ability, and user interaction protocols, wherein the leading virtual agent with the first large language model is trained to be an expert for high-level tasks, wherein the leading virtual agent is only one virtual agent that is informed that the leading virtual agent is configured to guide other agents to a higher-level task within the dual-layered artificial intelligence system, wherein the leading virtual agent is only virtual agent that is configured to interface with any customer, wherein the leading virtual agent is configured to perform any higher-level task that leads other task-specific agents;
a set of other virtual agents with a set of large language models individually, each of the set of other virtual agents is trained by a specified large language model of the set of large language models, wherein the set of large language models are trained with specialized focuses that are called upon at any given moment from the leading virtual agent, wherein the leading virtual agent is configured to monitor the set of other virtual agents, wherein the leading virtual agent is configured to ensure the set of other virtual agents to adhere to a broader set of goals, wherein a process of the monitoring and ensuring is analogous to how a teacher may use a curriculum to keep a course on track, wherein the process is configured to serve as guardrails to ensure that outputs stay within predefined parameters, wherein a set of predefined parameters comprise brand consistency, ethical considerations, and other overarching goals, wherein the set of other virtual agents are configured to have no knowledge that another virtual agent is guiding them, wherein the set of other agents are configured to communicate their interactions with users regularly to the leading virtual agent, wherein the leading virtual agent is configured to drives the set of other virtual agents to deliver optimal solutions,
and
an artificial intelligence engine coupled to both the leading virtual agent and the set of other virtual agents, wherein the artificial intelligence engine is configured to adjust input datasets and parameters of the first large language model, the second large language model and the set of large language models, wherein the artificial intelligence engine is configured to convey instructions from the leading virtual agent to the set of other virtual agents.

2. A method for providing services via a leading virtual agent and a set of other virtual agents with artificial intelligence, the method comprising:
detecting, by one or more processors, a request from a first user, wherein the request could be a request to be educated with a specifically tailored class with a set of other virtual agents with artificial intelligence, wherein a specifically tailored class is configured to execute a specific plan for the user for the education, wherein the leading virtual agent is trained with datasets that include goal setting, progress tracking, ethical guidelines, brand voice, and regulatory compliance, wherein the leading virtual agent with the first large language model is trained to be an expert for high-level tasks, wherein the leading virtual agent is only one virtual agent that is informed that the leading virtual agent is configured to guide other agents to a higher-level task, wherein the leading virtual agent is only one virtual agent interfacing with users, wherein the leading virtual agent is configured to monitor the set of other virtual agents, wherein the leading virtual agent is configured to ensure the set of other virtual agents to adhere to a broader set of goals;
activating a first other virtual agent of the set of other virtual agents with artificial intelligence, wherein the first other virtual agent is picked by the leading virtual agent with leading artificial intelligence, wherein the pick of the first other virtual agent is determined by specifics and configurations of the first other virtual agent and specific needs from the first user, wherein the first other virtual agent is configured to give educational information and specific material to the leading virtual agent, wherein the leading virtual agent is configured to preform educational service that comprises teaching the first user, interacting with the first user, answering questions from the first user, wherein the wherein the set of other virtual agents are configured to collaborate with each other, wherein the first other customer-facing virtual agent is interacting with the leading virtual agent, wherein an artificial intelligence engine is coupled to the one or more processors and a server and to the leading virtual agent and the set of customer-facing virtual agents, wherein the artificial intelligence engine is trained by human experts in the field, wherein the set of other virtual agents are configured to be displayed in LED/OLED displays, Android/iOS tablets, Laptops/PCs, smartphones, or VR/AR goggles, wherein a set of multi-layer info panels coupled to the one or more processors are configured to overlay graphics on top of the set of virtual agents, wherein any of the set of other virtual agents are configured to be displayed with an appearance of a real human or a humanoid or a cartoon character, wherein any of the set of virtual agents' gender, age and ethnicity is determined by the artificial Intelligence's analysis on input from the user, wherein any of the set of other virtual agents is configured to be displayed in full body or half body portrait mode, wherein the artificial intelligence engine is configured for real-time speech recognition, speech to text generation, real-time dialog generation, text to speech generation, voice-driven animation, and human avatar generation, wherein the artificial intelligence engine is configured to emulate different voices and use different languages;
modifying education activities from the first other virtual agent based on guidelines and input from the leading virtual agent with communication between the first other virtual agent and the leading virtual agent;
recording the modification and feedback from the first user; and
training other virtual agents of the set of other virtual agents based on the recording.

3. A method for providing services via a leading virtual agent and a set of other virtual agents with artificial intelligence, the method comprising:
detecting, by one or more processors, a request from a first user, wherein the request could be a request to be educated with a specifically tailored class with a set of other virtual agents with artificial intelligence, wherein a specifically tailored class is configured to execute a specific plan for the user for the education, wherein the leading virtual agent is trained with datasets that include goal setting, progress tracking, ethical guidelines, brand voice, and regulatory compliance, wherein the leading virtual agent with the first large language model is trained to be an expert for high-level tasks, wherein the leading virtual agent is only one virtual agent that is informed that the leading virtual agent is configured to guide other agents to a higher-level task, wherein the leading virtual agent is only one virtual agent interfacing with users, wherein the leading virtual agent is configured to monitor the set of other virtual agents, wherein the leading virtual agent is configured to ensure the set of other virtual agents to adhere to a broader set of goals;
activating a first other virtual agent of the set of other virtual agents with artificial intelligence, wherein the first other virtual agent is picked by the leading virtual agent with leading artificial intelligence, wherein the pick of the first other virtual agent is determined by specifics and configurations of the first other virtual agent and specific needs from the first user, wherein the first other virtual agent is configured to give educational information and specific material to the leading virtual agent, wherein the leading virtual agent is configured to preform educational service that comprises teaching the first user, interacting with the first user, answering questions from the first user, wherein the wherein the set of other virtual agents are configured to collaborate with each other, wherein the first other customer-facing virtual agent is interacting with the leading virtual agent, wherein an artificial intelligence engine is coupled to the one or more processors and a server and to the leading virtual agent and the set of customer-facing virtual agents, wherein the artificial intelligence engine is trained by human experts in the field, wherein the set of other virtual agents are configured to be displayed in LED/OLED displays, Android/iOS tablets, Laptops/PCs, smartphones, or VR/AR goggles, wherein a set of multi-layer info panels coupled to the one or more processors are configured to overlay graphics on top of the set of virtual agents, wherein any of the set of other virtual agents are configured to be displayed with an appearance of a real human or a humanoid or a cartoon character, wherein any of the set of virtual agents' gender, age and ethnicity is determined by the artificial Intelligence's analysis on input from the user, wherein any of the set of other virtual agents is configured to be displayed in full body or half body portrait mode, wherein the artificial intelligence engine is configured for real-time speech recognition, speech to text generation, real-time dialog generation, text to speech generation, voice-driven animation, and human avatar generation, wherein the artificial intelligence engine is configured to emulate different voices and use different languages;
modifying education activities from the first other virtual agent based on guidelines and input from the leading virtual agent with communication between the first other virtual agent and the leading virtual agent;
recording the modification and feedback from the first user; and
training other virtual agents of the set of other virtual agents based on the recording;
activating a second other virtual agent of the set of other virtual agents with artificial intelligence, wherein the second other virtual agent is picked by the leading virtual agent with leading artificial intelligence, wherein the pick of the second other virtual agent is determined by specifics and configurations of the second other virtual agent and specific needs from the second user, wherein the second other virtual agent is configured to give educational information and specific material to the leading virtual agent, wherein the leading virtual agent is configured to preform educational service that comprises teaching the second user, interacting with the second user, answering questions from the second user, wherein the wherein the set of other virtual agents are configured to collaborate with each other, wherein the second other customer-facing virtual agent is interacting with the leading virtual agent, wherein an artificial intelligence engine is coupled to the one or more processors and a server and to the leading virtual agent and the set of customer-facing virtual agents, wherein the artificial intelligence engine is trained by human experts in the field, wherein the set of other virtual agents are configured to be displayed in LED/OLED displays, Android/iOS tablets, Laptops/PCs, smartphones, or VR/AR goggles, wherein a set of multi-layer info panels coupled to the one or more processors are configured to overlay graphics on top of the set of virtual agents, wherein any of the set of other virtual agents are configured to be displayed with an appearance of a real human or a humanoid or a cartoon character, wherein any of the set of virtual agents' gender, age and ethnicity is determined by the artificial Intelligence's analysis on input from the user, wherein any of the set of other virtual agents is configured to be displayed in full body or half body portrait mode, wherein the artificial intelligence engine is configured for real-time speech recognition, speech to text generation, real-time dialog generation, text to speech generation, voice-driven animation, and human avatar generation, wherein the artificial intelligence engine is configured to emulate different voices and use different languages;
modifying education activities from the second other virtual agent based on guidelines and input from the leading virtual agent with communication between the second other virtual agent and the leading virtual agent;
recording the modification and feedback from the second user; and
training other virtual agents of the set of other virtual agents based on the recording.
